(19) United States
(12) Patent Application Publication
(10) Pub. No.: US 2025/0135733 A1
(43) Pub. Date: May 1, 2025

(54) SPIRAL WOUND PIPE INSULATION

(71) Applicant: Owens Corning Intellectual Capital, LLC, Toledo, OH (US)

(72) Inventors: Matthew Daniel Gawryla, Granville, OH (US); Mark Edward Mantonya, Newark, OH (US); Paul Edward Shawcross, Hilliard, OH (US); Christopher James Clements, Johnstown, OH (US); Benjamin Talbot Padgitt, Grove City, OH (US)

(21) Appl. No.: 18/919,808

(22) Filed: Oct. 18, 2024

Related U.S. Application Data
(60) Provisional application No. 63/593,557, filed on Oct. 27, 2023.

(51) Int. Cl. B29C 70/54; B29C 70/06; B29C 70/30; B29C 71/00; B29C 71/02; B29K 33/00; B29K 105/08; B29K 309/08; B29L 23/00; F16L 59/02

(52) U.S. Cl. CPC B29C 70/545; B29C 70/06; B29C 70/30; B29C 71/0009; B29C 71/02; F16L 59/027; B29C 2793/0063; B29C 2793/009; B29K 2033/00; B29K 2105/089; B29K 2309/08; B29L 2023/225

(57) ABSTRACT

A pipe insulation is formed from multiple discrete sheets of fiberglass that are wetted with a binder composition. The sheets are spiral wound around a mandrel in a partially overlapping fashion. The wound sheets are further processed to interface with one another and form a unitary elongated cylinder. The binder in the elongated cylinder is then cured to form the pipe insulation.

### CROSS-REFERENCE TO RELATED APPLICATION

This application claims priority to and any benefit of U.S. Provisional Application No. 63/593,557, filed Oct. 27, 2023, the content of which is incorporated herein by reference in its entirety.

### FIELD

The general inventive concepts relate to fibrous pipe insulation and, more specifically, to spiral wound pipe insulation.

### BACKGROUND

It is known to surround pipes with fibrous insulation, for example, to improve energy efficiency. A conventional process for forming fibrous pipe insulation is a continuous molded pipe (CMP) process. The CMP process is typically used to form smaller diameter pipe insulation, such as that having an inner diameter of 6 inches (15.24 cm) or less.

In the CMP process, raw materials (“batch”), which can include recycled glass cullet, are melted at a high temperature (e.g., greater than 2,000° F. (1,093.33° C.)) to produce molten glass. The molten glass is then used to form solid fibers, which are deposited on a conveyor to form a fibrous “pack” having a desired thickness. The pack is cut into specific lengths and/or widths that each form a “pelt” having the thickness. The width of the pelt approximately corresponds to a circumference of the pipe insulation being produced.

The pelt is then fed into a mold and folded around a fixed hollow mandrel centered within the mold. The mold itself is a hollow tube at least a portion of which is perforated so that heated air can be forced into and drawn out of the mold.

The pelt is cured in the mold and on the mandrel to form a pipe insulation section as a tubular body. In particular, the size of the mandrel defines the inner diameter of the tube. Likewise, the mold defines the outer diameter of the tube, with the distance between the mold and mandrel limiting the wall thickness of the tube.

The curing can be achieved by using multiple heat sources, such as an induction heater (at the beginning portion of the mold) for curing an outer surface of the tube and application of heated air both into the mold and through holes formed in the mandrel. Consequently, the outside of the tube is rigid, while the inside has a softer core that can be compressed to form around fittings and other complex pipe shapes.

The pipe insulation section is pulled through the mold using a woven fiberglass scrim, which is separated from the pipe insulation as it exits the mold.

As the pipe insulation section exits the mold, a longitudinal seam is cut fully through a top of the pipe insulation section and a partial longitudinal back cut is made along a bottom of the pipe insulation. These cuts facilitate subsequent installation of the pipe insulation around a pipe. The pipe insulation section exiting the mold is transversely cut into desired lengths (e.g., up to 36 inches (91.44 cm)) of pipe insulation.

In some embodiments, a jacket is applied (e.g., adhered) to an outer surface of the pipe insulation.

An exemplary pipe insulation 100 produced by a CMP or other conventional mandrel-based process, is shown (in cross-section) in FIG. 1. The pipe insulation 100 is formed from a fibrous insulating material 102 (e.g., fiberglass) as an elongated hollow cylinder having a wall thickness 104 and an inner cavity 106. The inner cavity 106 defines an inner diameter 108 of the pipe insulation 100. The inner diameter 108 of the pipe insulation 100 is selected to match an outer diameter of a pipe or pipe-like member to be insulated. An optional outer jacket 110 is wrapped around the insulating material 102 and acts as, amongst other things, a vapor barrier for the pipe insulation 100. The outer jacket 110 can also act as an aesthetic covering for the insulating material 102. A slit 112 is formed through the insulating material 102 to facilitate placement of the pipe insulation 100 around the pipe. To further facilitate installation of the pipe insulation 100, a partial slit 114 can also be formed, usually on an opposite side of the insulating material 102 from the slit 112. The partial slit 114 typically does not extend through the entire thickness 104 of the insulating material 102 (and does not breach the outer jacket 110). After the pipe insulation 100 is fitted around the pipe, a portion of the outer jacket 110 forms a cover 116 that extends over (and seals) the slit 112.

A drawback of the conventional molding process, as well as other fibrous pipe insulation production processes, is that they often involve a relatively slow production time, which significantly limits the amount of material that can be produced over a given period of time. For example, the conventional molding process may only be able to produce approximately twelve 3-foot (0.9144-meter) sections of the pipe insulation per minute. Thus, there is an unmet need for a faster, more efficient fibrous pipe insulation production process, which produces fibrous pipe insulation comparable to the slower conventional processes. Additionally, because the spiral winding process “builds up” the pipe insulation from multiple discrete layers, it may provide increased flexibility in product offerings or properties unachievable by conventional production processes. Furthermore, spiral wound pipe insulation may exhibit improved appearance and/or performance compared to conventional pipe insulation.

### SUMMARY

The general inventive concepts encompass a method of forming pipe insulation by interfacing discrete sheets of fibrous insulation material into a substantially unitary tubular body. In particular, the sheets are spirally wound around a mandrel or similar structure to form the pipe insulation.

In one exemplary embodiment, a method of forming pipe insulation is disclosed. The method comprises providing a plurality of sheets of insulation material, each sheet comprising a plurality of glass fibers and a binder; compressing each sheet of insulation material (e.g., to have a thickness in the range of about 1.5 mm to about 6.5 mm); drying each sheet of insulation material (e.g., to remove a majority of water therefrom); directing each sheet of insulation material toward a mandrel at an approach angle α, wherein α≠90 degrees; and spiral winding each sheet in a partially overlapping fashion around the mandrel to form an elongated hollow cylinder of the insulation material having a wall thickness in the range of about 10 mm to about 55 mm. The binder of each insulation sheet is substantially uncured when the sheet is spiral wound on the mandrel. In some embodiments, each sheet of insulation material has a width in the range of about 35 mm to about 80 mm. In some embodiments, each sheet of insulation material has a fiber area weight (FAW) in the range of about 195 g/m² to about 410 g/m². In some embodiments, each sheet of insulation material has a fiber basis weight variation that is in the range of about FAW±50%.

In some exemplary embodiments, each sheet of insulation material has a first scrim interfaced with a top surface of the sheet and a second scrim interfaced with a bottom surface of the sheet, wherein the first scrim and the second scrim are removed from the sheet after drying of the sheet and prior to spiral winding of the sheet.

In some exemplary embodiments, the method further comprises hydrating each sheet of insulation material on the mandrel by applying about 1 wt. % to about 5 wt. % of water to the sheet based on the weight of the sheet.

In some exemplary embodiments, the method further comprises kneading the sheets of insulation material on the mandrel to redistribute a portion of the binder situated at overlapping portions of the sheets.

In some exemplary embodiments, the method further comprises searing at least a portion of each innermost sheet (i.e., those contacting the mandrel) and a portion of each outermost sheet (i.e., those furthest from the mandrel) of insulation material on the mandrel.

In some exemplary embodiments, the searing comprises applying heat in the range of about 750° F. (398.89° C.) to about 900° F. (482.22° C.) to the innermost sheets and the outermost sheets for about ⅛ second to about 1 second.

In some exemplary embodiments, the method further comprises curing the binder of the elongated hollow cylinder on the mandrel.

In some exemplary embodiments, the curing comprises applying heat in the range of about 475° F. (246.11° C.) to about 650° F. (343.33° C.) to the sheets for at least about 5 seconds.

In some exemplary embodiments, the method further comprises cutting the elongated hollow cylinder to a desired length as it exits the mandrel.

In some exemplary embodiments, the method further comprises cutting a longitudinal slit into the length of the elongated hollow cylinder.

In some exemplary embodiments, the method further comprises applying an outer jacket material to the length of the elongated hollow cylinder.

In some exemplary embodiments, the spiral winding is effective to produce about twenty-four 3-foot (0.9144-meter) sections of the pipe insulation per minute.

In some exemplary embodiments, an inner cavity of the elongated hollow cylinder has a diameter of less than 67 mm.

In some exemplary embodiments, the fibers in each sheet have an average fiber diameter in the range of about 6 μm to about 9 μm.

In some exemplary embodiments, each sheet has about 5% LOI to about 8% LOI of the binder.

In some exemplary embodiments, the pipe insulation has a density in the range of about 56,000 g/m³ to about 88,000 g/m³.

In some exemplary embodiments, the uncured binder is substantially free of formaldehyde.

In some exemplary embodiments, the binder comprises polyacrylic acid and sorbitol.

In some exemplary embodiments, at least one belt is used to spiral wind the sheets along the mandrel.

In some exemplary embodiments, between 2 and 32 sheets are used to form the pipe insulation.

In some exemplary embodiments, a number of the sheets is selected to define a thickness of the elongated hollow cylinder of insulation material.

In some exemplary embodiments, the mandrel is fixed.

In some exemplary embodiments, the mandrel is hollow and includes a plurality of apertures extending therethrough.

In some exemplary embodiments, the pipe insulation is formed at a rate in excess of twelve 3-foot (0.9144-meter) sections of the pipe insulation per minute. In some exemplary embodiments, the pipe insulation is formed at a rate in excess of eighteen 3-foot (0.9144-meter) sections of the pipe insulation per minute. In some exemplary embodiments, the pipe insulation is formed at a rate of at least twenty-four 3-foot (0.9144-meter) sections of the pipe insulation per minute.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 is a cross-sectional view of a conventional pipe insulation.

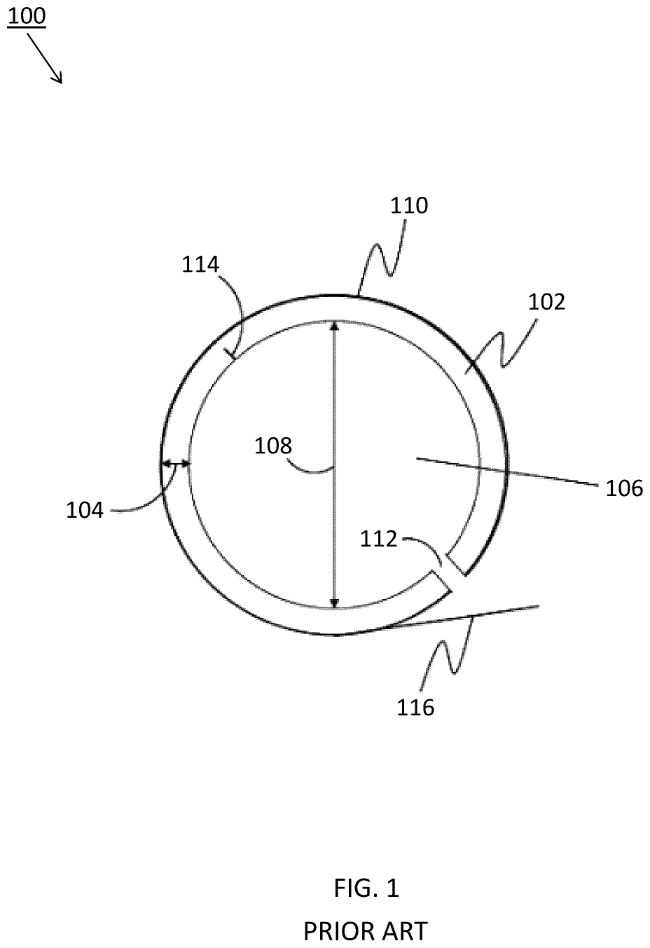

FIG. 2 is a cross-sectional diagram illustrating buckling of a cured fiberglass material being wound around a stationary mandrel.

FIG. 3 is a system for forming a fiberglass pelt for use in forming pipe insulation, according to one exemplary embodiment.

FIG. 4 is a diagram illustrating various spiral winding concepts.

FIG. 5 is a system for conditioning and sectioning the fiberglass pelt of FIG. 3, according to one exemplary embodiment.

FIG. 6 is a system for spiral winding the fiberglass sheets of FIG. 5, according to one exemplary embodiment.

FIG. 7 is a flowchart illustrating a method of forming spiral wound pipe insulation, according to one exemplary embodiment.

### DETAILED DESCRIPTION

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods, devices, and materials are now described. All references, publications, patents, patent applications, and commercial materials mentioned herein are incorporated herein by reference for all purposes including for describing and disclosing the methodologies which are reported in the publications which might be used in connection with the invention. Nothing herein is to be construed as an admission that the invention is not entitled to antedate such disclosure by virtue of prior invention.

The general inventive concepts relate to pipe insulation formed by spiral winding many binder-impregnated sheets of fibrous insulation material around a mandrel in a partially overlapping fashion and then curing the binder to form a substantially unitary tubular body (e.g., an elongated hollow cylinder). In some embodiments, the resulting spiral wound pipe insulation has an inner diameter of 6 inches (15.24 cm) or less.

Spiral winding fibrous pipe insulation, particularly at desired production speeds in excess of 30 feet (9.14 meter) per minute and, more preferably, greater than 60 feet (18.29 meter) per minute, gives rise to many technical challenges, several of which are described herein.

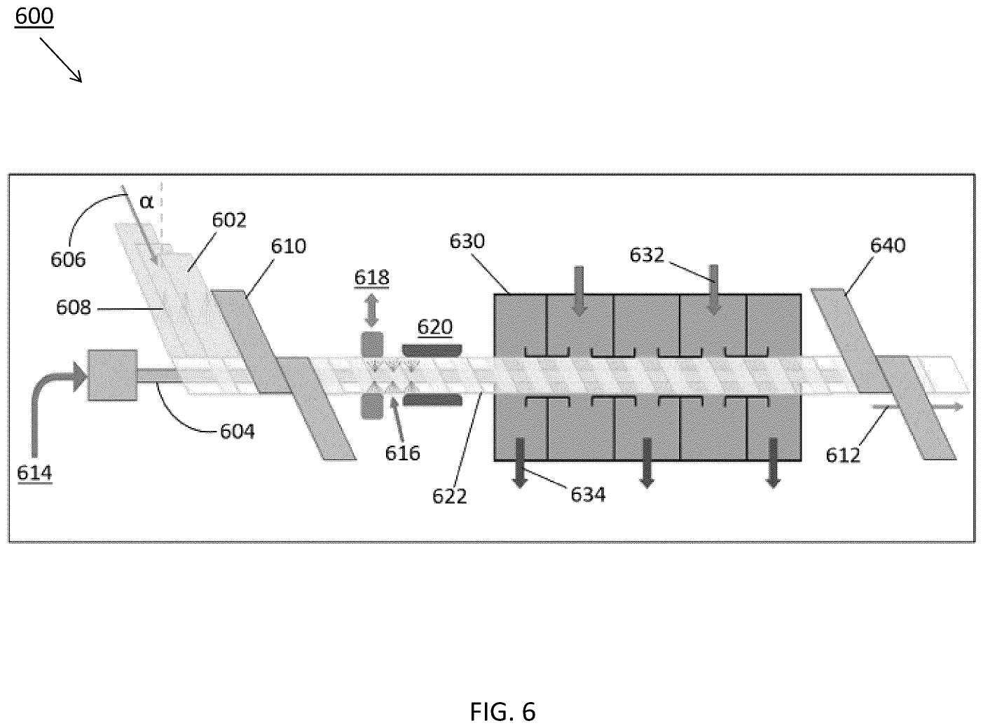

In the spiral winding process, several layers (e.g., sheets) of input fiberglass material are wrapped around a mandrel, with each sheet fed at a unique incident angle to the mandrel (see FIG. 6). In some embodiments, from 2 to 32 sheets of the fiberglass material are used to form the pipe insulation. In some embodiments, the number of sheets is selected to achieve a desired wall thickness of the pipe insulation. In some embodiments the wall thickness of the pipe insulation is in the range of about 10 mm to about 55 mm.

As an initial matter, each layer of fiberglass must have sufficient and relatively consistent material geometry and tensile strength for successful spiral winding. If the input material is not sufficiently homogenous (within and across layers), stable, and strong, the layers may become damaged (e.g., tear) during the winding process and/or not behave (e.g., align on the mandrel) as needed to form the pipe insulation. These requirements are particularly important at high winding speeds when the layers are under increased tension.

One way of obtaining fiberglass layers that meet these requirements is through the application of binder to the fiberglass followed by activating (i.e., curing) the binder. Curing the binder causes the fiberglass layer to become thin and stiff, while also setting its shape (i.e., the fiberglass will retain the shape it has at the time of curing).

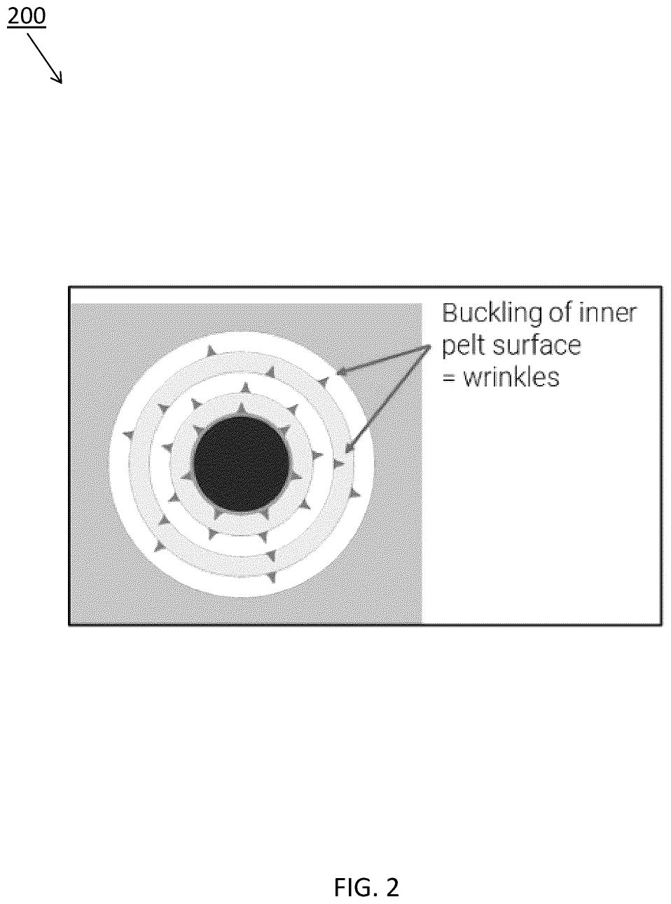

While curing the fiberglass layers prior to spiral winding imparts the necessary tensile strength and structural/geometric integrity, it introduces at least three significant challenges with making spirally wound pipe insulation. First, spirally winding the rigid flat material around a mandrel will tend to create folds and wrinkles in the material as the material bends around the mandrel (see FIG. 2), which can detrimentally affect product appearance and performance. Second, after spiral winding, the pipe insulation needs to be cut along its length in order for it to be placed over pipe sections. Cutting the cured material would cause the wound fiberglass to undesirably “open up” or otherwise attempt to flatten out based on the flat panel shape it had at the time of curing. Lastly, the cured layers of fiberglass will not allow the glass fibers within each of the fiberglass layers to relax and intermix with adjacent layers at the layer-to-layer interfaces. Thus, instead of a substantially unitary pipe insulation, the pipe insulation would behave more like a laminate. This is not ideal for filleting (i.e., manually cutting out) sections of pipe insulation to a specific depth, since the laminate structure would tend to cause the insulation layers to separate at the layer-to-layer interfaces versus the desired depth.

In some embodiments, the aforementioned problems are mitigated by applying a two-stage binder to the fiberglass layers. The first stage of the binder can be sufficient to impart the necessary material geometry and tensile strength to the fiberglass layers, while also allowing the fiberglass layers to be spirally wound without producing significant wrinkles or folds. Then, once the fiberglass layers are spirally wound on the mandrel, the second stage of the binder can be activated to relax the fibers to promote fiber intermixing at the layer interfaces, and to newly set the shape of the insulation, thus addressing the filleting and shape resetting issues.

In some embodiments, a water-soluble binder and moisture are used. In the first stage, the fiberglass material is treated with the water-soluble binder. The layers are then dried (but not cured) to remove any moisture. As the layers are being dried, they are also mechanically compressed to get the fiberglass material to the target thickness. At this point, the fiberglass material can satisfy the geometry and tensile strength requirements, while at the same time not “locking in” the shape of the cured profile as with the binder curing process. The material can then be spirally wound around a mandrel to form the proper pipe insulation shape. Once the layers are wound around the mandrel, the second stage can begin. In the second stage, moisture can be reintroduced into the fiberglass material (e.g., via steam) to rehydrate the binder. As the binder becomes fluid, the bonds that were holding the fibers together release, which allows the fibers to move relative to one another (i.e., releasing some of the stored energy in the fibers). The fiberglass material will begin to expand and swell as a result. A physical barrier placed around the outer diameter of the fiberglass body and/or searing the outer diameter of the body can be used to provide rigidity at the outer diameter surface and prevent further bulk expansion in the radial direction. As a result, the fibers within the wound body can be linked together as the binder continues to cure (i.e., cross-link) within the fiberglass body. The cured binder sets the final shape of the fiberglass body. The relaxation and intermixing (e.g., entangling) of the fibers prior to curing of the binder promotes a more unitary body.

In some embodiments, the two-stage binder comprises a thermoplastic stage and a thermosetting stage. In some embodiments, a blocked thermosetting binder material is used, in which fiber cross-linking does not occur until a critical temperature is reached. The general inventive concepts encompass any other suitable technique for meeting the necessary geometry and tensile strength requirements so that the fiberglass layers may be spirally wound, particularly at production speeds greater than 30 feet (9.14 meter) per minute and, more preferably, greater than 60 feet (18.29 meter) per minute. In other words, the technique should allow for the efficient handling of the fiberglass layers, conforming of the fiberglass layers to the shape of the mandrel, adhering the fiberglass layers to one another, and curing the fiberglass layers to form a unitary body of pipe insulation.

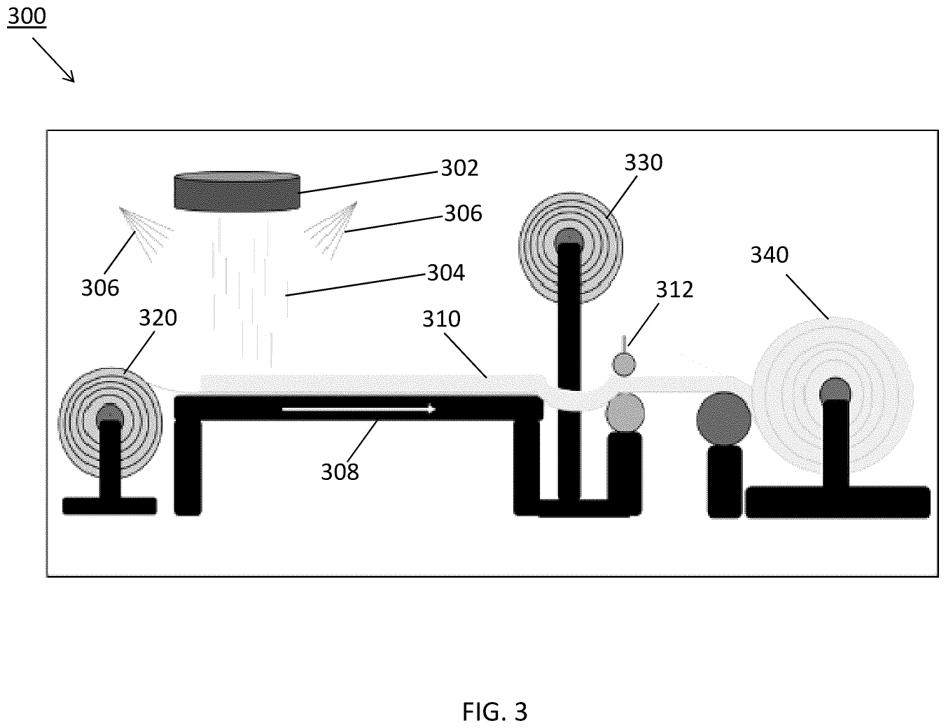

A system 300 or module for generating fiberglass material suitable for use in forming spiral wound pipe insulation, according to an exemplary embodiment, is shown in FIG. 3.

In the illustrative system 300, a fiber forming station 302 or other fiber source provides glass fibers 304 to which a binder 306 is applied (e.g., sprayed).

The glass fibers 304 have an average diameter in the range of about 20 HT (5.1 μm) to about 36 HT (8.9 μm). In some embodiments, the glass fibers 304 has an average fiber diameter of about 33 HT (8.4 μm). The glass fibers 304 are formed or manipulated (e.g., chopped) to have a desired average length.

The binder 306 is typically an aqueous binder 306 composition. In some embodiments, the binder 306 is substantially free of any added formaldehyde. In some embodiments, the binder 306 comprises polyacrylic acid and sorbitol.

In some embodiments, the binder 306 constitutes from about 2% LOI to about 12% LOI. In some embodiments, the binder 306 constitutes about 6.5% LOI.

In some embodiments, the binder 306 is a composition described or suggested in U.S. 2022/0106419, the entire disclosure of which is incorporated herein by reference. These binders have properties (e.g., hygroscopicity, water solubility, low viscosity) that facilitate conditioning a fiberglass pelt in the inventive spiral winding applications.

In some embodiments, a bottom scrim 320 is fed onto a conveyor 308. The glass fibers 304 with the binder 306 applied thereto are deposited on the bottom scrim 320 situated on the conveyor 308. In this manner, the glass fibers 304 impregnated with the binder 306 form a fiberglass pelt 310. In some embodiments, the conveyor 308 moves at a speed of about 5 feet (1.52 meter) per minute to about 25 feet (7.62 meter) per minute.

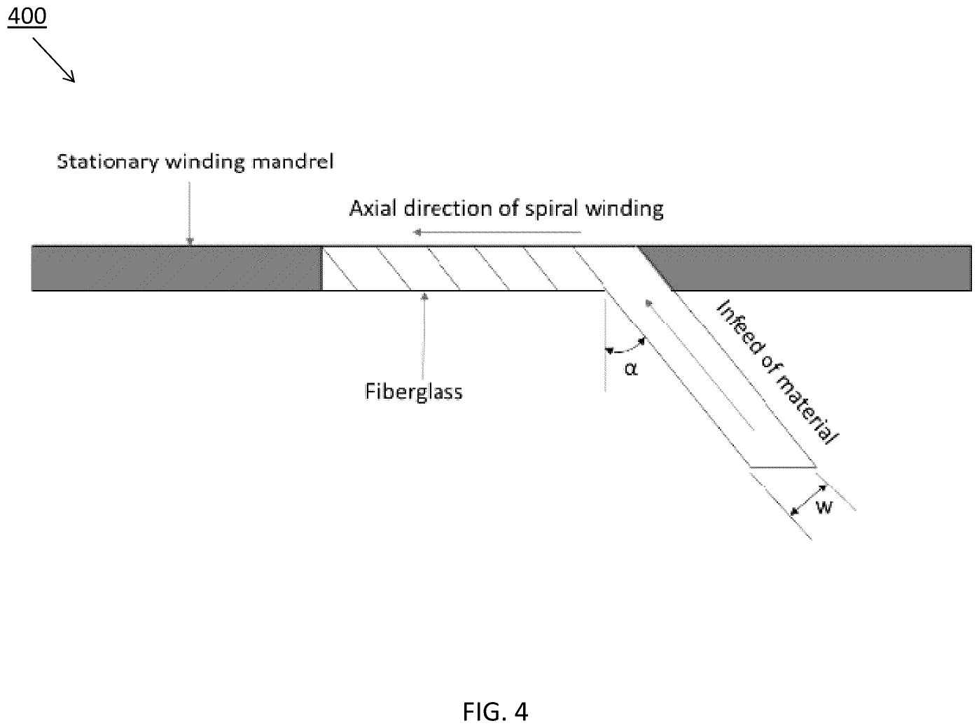

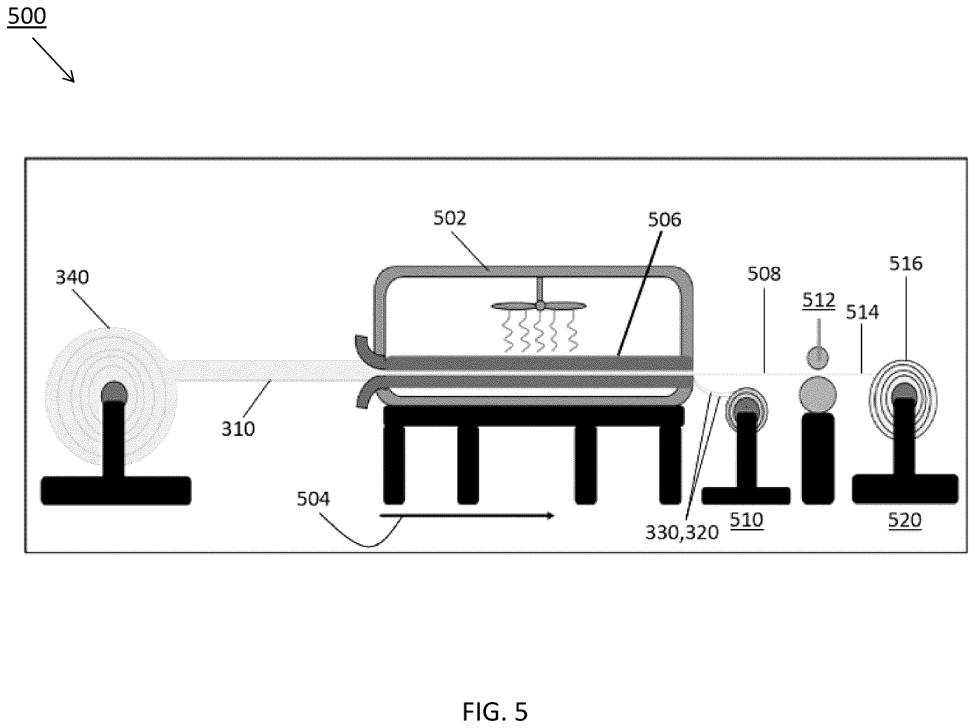

As the fiberglass pelt 310 moves past the conveyor 308, a trimmer 312 removes excess material from the edges of the fiberglass pelt 310. Consequently, the fiberglass pelt 310 is appropriately sized to form many individual fiberglass sheets therefrom (see FIG. 4). In some embodiments, after passing the trimmer 312, a top scrim 330 is applied to the fiberglass pelt 310. The fiberglass pelt 310 including the scrims 320, 330 is then rolled onto a roll 340. Assuming that the necessary criteria is met, the roll 340 of fiberglass material (i.e., the fiberglass pelt 310) can be used to form the fiberglass sheets and the fiberglass sheets can be used to form the spiral wound pipe insulation. For example, as described herein, the distribution of the fibers 304 in the pelt 310 needs to be consistent with minimal variation so that the sheets formed therefrom (see FIG. 5) are likewise consistent with one another, which is critical when the sheets are fed to the spiral winder (see FIG. 6). In general, use of the scrims 320, 330 is optional.

It was found that to successfully wind an uncured fiberglass material into a spiral tube, the input material must be dimensionally stable and have sufficient tensile strength to prevent pelt breakage when being drawn onto the mandrel. The pelt must also exhibit sufficient shear strength to withstand and evenly distribute the applied driving force from the winder belt through the pelt without causing the pelt to lose integrity.

Uncured or undried and uncompressed pelts were found to exhibit area weight variations that render the pelts difficult to consistently guide onto a spiral winder mandrel. The extremely low compressive strength of the uncured pelts precludes the use of edge guides to control the path of the pelts, as the pelts will locally deform (compress) as they press against the guides. Therefore, tension is the preferred means of controlling an unstable pelt. However, the tension through the unstable pelt follows a path dictated by the regions of highest fiber density, as these regions generally exhibit higher tensile strength and less elongation under stress than the lower density regions. When the unstable pelt is placed under tension, the tensile load path, which is defined by the high-density regions, is drawn into an approximately straight line. The randomly distributed lighter density regions bounding the tensile path then define the edges of the unstable pelt as it is wound onto the mandrel. The resulting pelt edges are no longer straight, making consistent alignment with the adjacent wound pelt edge almost impossible without active pelt alignment. The density variation of the unstable pelts also causes problems when either overwinding additional layers to build thickness or overlapping adjacent wraps to build structural integrity. The low-density regions compress more than the high-density regions. Generally, when winding an unstable pelt under tension, the pelt will tend to follow a path that is influenced by the local sum density with the adjacent pelts. The pelt will tend to track towards low sum density regions and away from high sum density regions. This makes production of a consistent pipe section from an unstable pelt unfeasible.

It was found that by drying the glass pelt at a consistent, compressed thickness, the physical properties are significantly improved. For example, an uncured pelt may have a tensile strength of around 5 pounds compared to a tensile strength of over 25 pounds if the same pelt were compressed and dried. This improvement is the result of the additional solid bonds that are formed under compression. In some exemplary embodiments, the binder consists primarily of sorbitol and polyacrylic acid. When fully dried, but not cured, the binder produces a functional bond between two or more adjacent fibers. This binder formulation is very hygroscopic, capable of absorbing sufficient water from the atmosphere when the relative humidity is above 35% to allow the binder to become fluid. When the binder is sufficiently hydrated, its viscosity is low enough to allow fiber displacement within the pack structure. With higher tensile, compressive, and shear strength, the dried pelt becomes dimensionally stable under the loads applied for winding. The pelt path can be controlled (e.g., with edge guides) and local density variations have a minimal impact on pelt tracking during winding.

Furthermore, failure to maintain dimensional stability of the uncured pelt compromises the compressive, tensile, and shear strength of the pelt and the quality of the spiral winding. As the dimensional stability is reduced, the overall stability of the pelt is reduced, and this degrades winding performance. FIG. 4 provides a simplified diagram of the spiral winding process to help illustrate the importance of dimensional stability. The winding angle α in FIG. 4 is defined by the width of the fiberglass pelt width (i.e., w in FIG. 4) and its thickness. In general, the thinner the material, the easier it is to wind from a geometry standpoint to avoid gaps along the thickness of the material from spiral-to-spiral. An inconsistent width along the length of the pelt would require dynamic adjustments of the wind angle, which is undesired. Thickness changes through a run would require dynamic adjustment of the pelt width, which is not possible.

The formation of wrinkles on the inner surface of a wound pelt caused by the wrapping of the material around the mandrel, as described above, is also a function of pelt thickness. The strength of the binder bonds is sufficient to prevent any significant in-plane stretching or compression of the pelt, so the wrinkles are formed when the inner surface fibers buckle in response to the compressive force that results from the circumferential difference between the inner and outer surfaces of the wound pelt. Thinner pelts result in a smaller circumferential difference between the surfaces which results in smaller wrinkles. In general, the infeed material (e.g., the sheets 514) for the spiral winding processes should typically be “as thin as practical.”

Thus, there is an interplay between the physical properties of each fiberglass sheet and its dimensional stability. The width and thickness of the sheet needs to be consistent across the length of the sheet and the thickness should be “as thin as practical” to facilitate qualitatively good spiral winding from a geometry standpoint. The compressive (i.e., “squeezing” of the material against the winding mandrel by the spiral winder belt), tensile (i.e., the pull on the material from the belt as it is pulled to the spiral winder), and shear (i.e., tearing induced by the angle at which the material is fed to the winder) strengths should be sufficient enough to avoid affecting the sheet dimensional stability via physical deformation of the sheet from a mechanics standpoint.

Furthermore, the effects of humidity on the dimensional stability of the input material were considered. In some embodiments, a binder composition used in the input material (such as a binder composition described in U.S. 2022/0106419) is very hygroscopic, capable of absorbing sufficient water from the atmosphere when the relative humidity is above 35%. In these cases, the dried, compressed fiberglass sheets will benefit from some means to prevent absorption of moisture from the air, which could cause re-lofting of the sheets. Humidity controlled storage and manufacturing spaces could prevent ambient re-hydration.

In some embodiments, the binder composition is formulated to maintain sheet dimensional stability under typical ambient humidity conditions. For example, the binder composition could include a secondary thermoplastic binder component that is strong enough to hold the sheet in its desired state in the presence of high humidity, but that exhibits a low Tg with a sharp viscosity drop above 120° F. (48.89° C.) so it fully releases all fiber bonds, while becoming liquid below 135° F. (57.22° C.) so it can form around the fibers at a temperature below the curing temperature of the binder and then create a bond upon cooling.

In view of the above, it was found that both drying and compressing an uncured fiberglass material to form sheets having a specified width and thickness could render the material dimensionally stable and impart sufficient compressive, tensile, and shear strength to the material to support forming a tubular insulation body by spiral winding. In some instances, controlling behavior of the binder composition prior to spiral winding of the uncured fiberglass material is also important.

A system 500 or module for generating fiberglass sheets or layers suitable for use in forming spiral wound pipe insulation, according to an exemplary embodiment, is shown in FIG. 5. The system 500 conditions and sections a suitable fiberglass material, such as the roll 340 of fiberglass material (i.e., the fiberglass pelt 310) produced by the system 300.

In the illustrative system 500, the roll 340 of fiberglass material is unwound and fed (as fiberglass pelt 310) to an oven 502. In particular, the pelt 310 is pulled through the oven 502 in the direction indicated by the arrow 504. For example, the pelt 310 is pulled in the direction 504 by a winder 510 that exerts tension on the top scrim 330 and the bottom scrim 320 of the pelt 310. The oven 502 dries (but does not cure) the pelt 310 to remove a substantial portion, if not all, of the water present in the binder of the pelt 310.

In general, the drying should remove an amount of moisture that prevents any softening or flow of the binder at a given temperature over a period of time (e.g., 72 hours). In some embodiments, the amount of moisture removed ensures dimensional stability of the fiberglass pelt 310 when the material is subsequently exposed to a relative humidity of 30% or less.

Additionally, the pelt 310 is pulled (by the winder 510) through a fixture 506 situated in (e.g., extending through) the oven 502. The fixture 506 compresses the pelt 310 to a desired thickness and maintains the pelt 310 at this thickness, while it is being dried in the oven 502. In some embodiments, the desired thickness is in the range of about 1.5 mm to about 6.5 mm.

It is important that compression of the pelt 310 begins before the pelt 310 is dried. Accordingly, the pelt 310 may enter the fixture 506 prior to or at the entrance of the oven 502. In some embodiments, at least a portion of the fixture 506 in the oven 502 is perforated to facilitate drying of the material passing through the fixture 506.

As the dried and compressed pelt 508 exits the oven 502, the upper scrim 330 and the lower scrim 320 are removed from the pelt 508 (e.g., by the winder 510). In this manner, the dried and compressed pelt 508 continues to a slitting station 512, wherein the pelt 508 is separated (e.g., cut) into multiple discrete sheets 514 having a desired width. In some exemplary embodiments, the pelt 508 has a width of about 12 inches (30.48 cm) and is slit to form multiple sheets that each have the same desired width. In some embodiments, the desired width is in the range of about 35 mm to about 80 mm.

The sheets 514 are collected on one or more rolls 516 (e.g., by a winder 520) for subsequent use in forming the spiral wound pipe insulation.

As a measure of material consistency, the individual fiberglass sheets 514 produced by the system 500 each have a fiber area weight (FAW) in the range of about 195 g/m² to about 410 g/m² and a fiber basis weight variation that is in the range of about FAW±50%. Thus, any variation in the FAW along the length of the fiberglass sheet 514 (e.g., when measured in 1-foot (0.9144-meter) increments) should be within ±50% of the FAW. The fiber basis weight variation could be measured, for example, by X-ray gauge measurement.

With suitable input material (e.g., the sheets 514), a spiral winding process can wind multiple layers of the input material around a stationary mandrel to form and set a desired shape corresponding to the pipe insulation body. In some embodiments, the pipe insulation body is an elongated hollow cylinder with a wall thickness in the range of about 10 mm to about 55 mm.

A system 600 or module for forming spiral wound pipe insulation, according to an exemplary embodiment, is shown in FIG. 6. The pipe insulation can be formed at a relatively high speed (e.g., greater than 60 feet (18.29 meter) per minute) with minimal gaps, wrinkling, and bunching.

In the illustrative system 600, multiple layers (e.g., 2-32 layers) of an input material 602 (e.g., the sheets 514) are fed to a stationary mandrel 604. Each layer of the input material 602 has approximately the same thickness (e.g., about 1.5 mm to about 6.5 mm) and approximately the same width (e.g., about 35 mm to about 80 mm).

The feed direction, shown by arrow 606, forms the approach angle α of the input material 602 to the mandrel 604. The angle α is not equal to 90 degrees. The layers of the input material 602 can overlap with one another on the mandrel 604 to build up a desired wall thickness. In some embodiments, water 608 is applied (e.g., sprayed) on the fiberglass layers as they are fed to the spiral winder to begin rehydrating the layers. Likewise, in some embodiments, a binder/water mixture can be applied (e.g., sprayed) on the fiberglass layers as they are fed to the spiral winder to improve adhesion.

A primary winder 610 is formed from a belt driven by a pair of rotating shafts. A middle section of the belt is wound or twisted around the mandrel 604 in a manner that allows it to contact the layers of the input material 602 on the mandrel 604. Accordingly, rotation of the belt drives the input material 602 down along a length of the mandrel 604 in the production direction, shown by arrow 612.

Once the individual layers of the input material 602 are on the mandrel 604 and being advanced along its length by the primary winder 610, additional processing of the input material 602 is required to form the unitary tubular body (i.e., the pipe insulation).

In some embodiments of the system 600, water 608 can be applied (e.g., spayed) on the layers of the input material 602 before the layers are wound on the mandrel 604, as described above. The amount of water 608 applied to the layers is at least approximately 1% of the weight of the incoming fiberglass layers and no more than 5% of the weight of the layers.

In some embodiments of the system 600, instead of or in addition to the water 608 being applied to the layers of the input material 602, a source of saturated steam 614 can be applied at a similar mass flow ratio as the water. For example, 0 to 50% of the steam 614 can be applied internally into the mandrel 604, flowing into the fiberglass through holes 616 along the length and circumference of the mandrel 604. The remaining balance (50 to 100%) of the steam 614 can be applied to the outer surface of the fiberglass on the mandrel 604 via an annular nozzle arrangement located in proximity to the mandrel 604. The total water applied in this case would still be in the range of approximately 1% to 5% of the fiberglass weight.

In either case, rehydration of the previously compressed and dried fiberglass sheets 514, as the input material 602, restores the binder to a fluid state and allows the fiberglass material to begin uncompressing (i.e., re-loft), which can aid in further processing of the fiberglass material on the mandrel 604. For example, rehydrating the binder can promote binder and fiber mobility, relieve internal fiber stresses, relax wrinkles, form new bonds, and facilitate interlayer bonding. In some embodiments, as the input material 602 swells in thickness, an outer physical barrier (e.g., rigid sleeve) could be used to constrain its ultimate thickness.

In some embodiments of the system 600, the fiberglass layers (e.g., the sheets 514) on the mandrel 604 are physically manipulated. For example, a kneading mechanism 618 can engage the fiberglass layers on the mandrel 604. In some embodiments, the kneading mechanism 618 comprises a ring surrounding the layers on the mandrel 604 and rotating at an absolute speed equivalent to the surface speed of the layers progressing down the mandrel 604. The ring could have several (e.g., 2-4) rollers on it. The rollers would press down into the glass while rotating in the circumferential direction so that the motion of the glass is going in the machine direction 612. Massaging the discrete fiberglass layers is done to induce fiber-to-fiber sliding within the layers, which causes binder displacement to redistribute the binder at the layer interfaces. This process helps disrupt the discrete layer arrangement through the thickness and the length of the tubular body being formed on the mandrel 604, as well as facilitating new bond formation and providing wrinkle relief. One of ordinary skill in the art will appreciate that other mechanical means could be used instead of the exemplary kneading mechanism 618 to achieve these results.

In some embodiments of the system 600, the fiberglass layers (e.g., the sheets 514) closest to and furthest from the mandrel 604 are subjected to an initial (i.e., pre-curing) heating application by a searing mechanism 620. In some embodiments, the searing mechanism 620 is an inductively heated sleeve and an inductively heated steel mandrel (e.g., the mandrel 604) between which the sheets are situated. The heated sleeve contacts the outermost layers and the heated mandrel contacts the innermost layers.

The searing mechanism 620 rapidly dries and cures the binder in a shallow zone located near the outer and inner surfaces of the wound fiberglass layers to stabilize the tubular body being formed, add tensile strength, and minimize binder fouling. Depending on the production speed (e.g., 60 feet (18.29 meter) per minute), the searing mechanism 620 may be able to create the necessary outer “crust” by application of heat in the range of about 750° F. (398.89° C.) to about 900° F. (482.22° C.) for about ⅛ second to about 1 second. The seared layers 622 are more of a unitary structure as a result of the searing.

The seared layers 622 are then driven along a portion of the mandrel 604 that passes through an oven 630. Heated air 632 is introduced (e.g., flows) into the oven 630, surrounds the seared layers 622 on the mandrel 604, and then exits the oven 630 as cooler air 634. Thus, the forced hot-air convection oven 630 removes excess moisture from the seared layers and cures (i.e., cross-links) the binder therein. Typically, the seared layers 622 are cured as quickly as possible within the oven 630.

In some embodiments of the system 600, an optional secondary winder 640 is utilized. The secondary winder 640 is formed from a belt driven by a pair of rotating shafts. A middle section of the belt is wound or twisted around the mandrel 604 in a manner that allows it to contact the layers of the input material 602 on the mandrel 604. Accordingly, rotation of the belt further drives the input material 602 down along a length of the mandrel 604 in the production direction 612. If necessary, the secondary winder 640 provides pulling force to aid in moving the wound fiberglass material along the mandrel 604. If the secondary winder 640 is used, its belt rotational speed should be synchronized to the belt rotational speed of the primary winder 610. Additionally, tension control could be used to avoid overly compressing or crushing the pipe insulation section.

In some embodiments, the spiral winding and the other processing steps involved in setting the shape of the pipe insulation occur on the same stationary mandrel 604, which can avoid problems that might arise with moving the unfinished fiberglass material from one location (e.g., mandrel) to another.

In the system 600, further processing of the spiral wound pipe insulation (i.e., the tubular body formed from the discrete layers) can involve cutting a section from the tubular body having a desired length (e.g., up to 36 inches (91.44 cm)), cutting the necessary slits into the tubular body section so that it can be installed around a pipe, adding an outer jacket material to the tubular body section, etc.

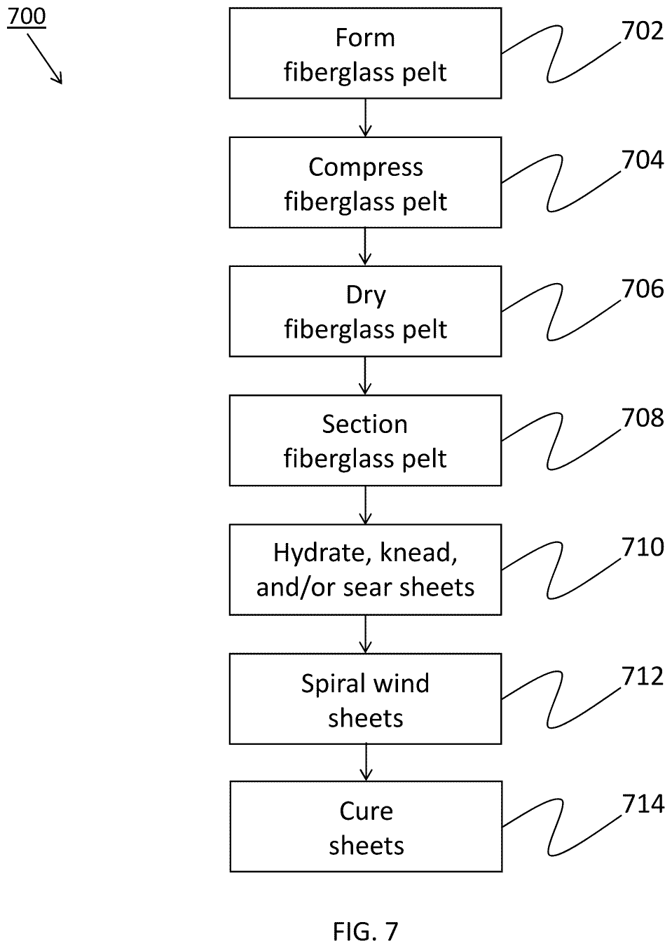

A method 700 of forming a spiral wound pipe insulation, according to an exemplary embodiment, is shown in FIG. 7.

In the method 700, a suitable fiberglass pelt is formed in step 702. The fiberglass pelt is formed from glass fibers and an aqueous binder applied to the glass fibers. The binder-impregnated glass fibers are situated between an upper scrim and a lower scrim. After being trimmed to a desired width, the fiberglass pelt situated between the two scrims is wound onto a roll for subsequent processing.

As described above, to be suitable for spiral winding, the fiberglass pelt should have substantially consistent dimensions (e.g., width, thickness) along its length, fiber distribution, binder distribution, and physical properties (e.g., tensile strength, compressive strength, shear strength).

To further condition the fiberglass pelt for spiral winding, the undried fiberglass pelt is compressed in step 704 to a reduced thickness. In some embodiments, the reduced thickness is in the range of about 1.5 mm to about 6.5 mm.

To further condition the fiberglass pelt for spiral winding, the compressed fiberglass pelt is dried in step 706 to remove a majority of the water from the pelt and, in particular, the binder of the pelt. In some embodiments, substantially all of the water is removed by the drying.

To further condition the fiberglass pelt for spiral winding, the compressed and dried fiberglass pelt is sectioned in step 708 to create multiple discrete sheets or layers from the single pelt. The widths of the sheets may vary based on the position or layer where the sheets are being applied during the winding. Ideally, each sheet will have a relatively consistent fibrous distribution along its length (i.e., across its width and thickness).

To further condition the fiberglass pelt for spiral winding, the sectioned fiberglass pelt (i.e., the sheets) can be subjected to one or more of rehydrating, kneading, and searing in step 710.

Hydrating the sheets may involve application of water (e.g., liquid water and/or steam) prior to the sheets being wound onto the mandrel and/or after the sheets have been wound onto the mandrel. In some embodiments, about 1 wt. % to about 5 wt. % of water is applied to each sheet of the fiberglass material based on the weight of the sheet.

Kneading the sheets may involve mechanically massaging the sheets on the mandrel, for example, to redistribute a portion of the binder situated between the sheets (layers) to improve inter-laminar bonding.

Searing the sheets may involve application of sufficient heat to quickly (e.g., within 1 second) harden the outer surface and/or the inner surface of the tubular body formed from the overlapped sheets on the mandrel. The seared outer surface and/or inner surface stabilizes the tubular body being formed by the sheets.

Finally, in step 712, the sheets on the mandrel are cured. For example, the sheets on the mandrel may travel through an oven where sufficient heat is encountered to cure (i.e., cross-link) the binder and “lock in” the tubular shape of the fibrous material to form the pipe insulation body. Because the fiberglass material is first spirally wound into its final shape and then cured, the material is locked in a spiral shape and can be further processed (e.g., cut longitudinally) without issues. Therefore, it is important to work with uncured material from the moment when the fiberglass material is formed up until it has been spirally wound.

Consistent with the method 700, further downstream processing of the spiral wound pipe insulation (i.e., the tubular body formed from the discrete sheets) can involve cutting a section from the tubular body having a desired length (e.g., up to 36 inches (91.44 cm)), cutting the necessary slits into the tubular body section so that it can be installed around a pipe, adding an outer jacket material to the tubular body section, etc.

The inventive systems and methods described and suggested herein represent a more efficient and customizable approach to forming fibrous pipe insulation.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications thereto. For example, while the pipe insulation is described herein as formed from glass fibers, other types of fibrous insulation material (e.g., mineral wool) may also be suitable. It is sought, therefore, to cover all such changes and modifications as fall within the spirit and scope of the general inventive concepts, as described and/or claimed herein, and any equivalents thereof.

What is claimed is:

1. A method of forming pipe insulation, the method comprising:
providing a plurality of sheets of insulation material, each sheet comprising a plurality of glass fibers and a binder;
compressing each sheet of insulation material to have a thickness in the range of about 1.5 mm to about 6.5 mm;
drying each sheet of insulation material to remove a majority of water therefrom;
directing each sheet of insulation material toward a mandrel at an approach angle α, wherein α≠90 degrees; and
spiral winding each sheet in a partially overlapping fashion around the mandrel to form an elongated hollow cylinder of the insulation material having a wall thickness in the range of about 10 mm to about 55 mm;
wherein each sheet of insulation material has a width in the range of about 35 mm to 80 mm;
wherein each sheet of insulation material has a fiber area weight (FAW) in the range of about 195 g/m² to about 410 g/m²;
wherein each sheet of insulation material has a fiber basis weight variation that is in the range of about FAW±50%; and
wherein the binder of each insulation sheet is substantially uncured when the sheet is spiral wound on the mandrel.

2. The method of claim 1, wherein each sheet of insulation material has a first scrim interfaced with a top surface of the sheet and a second scrim interfaced with a bottom surface of the sheet, and
wherein the first scrim and the second scrim are removed from the sheet after drying of the sheet and prior to spiral winding of the sheet.

3. The method of claim 1, further comprising hydrating each sheet of insulation material on the mandrel by applying about 1 wt. % to about 5 wt. % of water to the sheet based on the weight of the sheet.

4. The method of claim 1, further comprising kneading the sheets of insulation material on the mandrel to redistribute a portion of the binder situated at overlapping portions of the sheets.

5. The method of claim 1, further comprising searing the innermost and the outermost sheets of insulation material on the mandrel.

6. The method of claim 5, wherein the searing comprises applying heat in the range of about 750° F. (398.89° C.) to about 900° F. (482.22° C.) to the innermost and the outermost sheets for about ⅛ second to about 1 second.

7. The method of claim 1, further comprising curing the binder of the elongated hollow cylinder on the mandrel.

8. The method of claim 7, wherein the curing comprises applying heat in the range of about 475° F. (246.11° C.) to about 650° F. (343.33° C.) to the sheets for at least about 5 seconds.

9. The method of claim 1, further comprising cutting the elongated hollow cylinder to a desired length as it exits the mandrel.

10. The method of claim 9, further comprising cutting a longitudinal slit into the length of the elongated hollow cylinder.

11. The method of claim 10, further comprising applying an outer jacket material to the length of the elongated hollow cylinder.

12. The method of claim 1, wherein the spiral winding is effective to produce about twenty-four 3-foot (0.9144-meter) sections of the pipe insulation per minute.

13. The method of claim 1, wherein an inner cavity of the elongated hollow cylinder has a diameter of less than 67 mm.

14. The method of claim 1, wherein the fibers in each sheet have an average fiber diameter in the range of about 6 μm to about 9 μm.

15. The method of claim 1, wherein each sheet has about 5% LOI to about 8% LOI of the binder.

16. The method of claim 1, wherein the pipe insulation has a density in the range of about 56,000 g/m³ to about 88,000 g/m³.

17. The method of claim 1, wherein the uncured binder is substantially free of formaldehyde.

18. The method of claim 1, wherein the binder comprises polyacrylic acid and sorbitol.

19. The method of claim 1, wherein at least one belt is used to spiral wind the sheets along the mandrel.

20. The method of claim 1, wherein between 2 and 32 sheets are used to form the pipe insulation.

21. The method of claim 1, wherein a number of the sheets is selected to define a thickness of the elongated hollow cylinder of insulation material.

22. The method of claim 1, wherein the mandrel is fixed.

23. The method of claim 1, wherein the mandrel is hollow and includes a plurality of apertures extending therethrough.

24. The method of claim 1, wherein the pipe insulation is formed at a rate in excess of twelve 3-foot (0.9144-meter) sections of the pipe insulation per minute.
